(19) United States
(12) Patent Application Publication
(10) Pub. No.: US 2011/0287155 A1
(43) Pub. Date: Nov. 24, 2011

(54) METHOD FOR PRODUCING FLAVOR MATERIAL

(76) Inventors: Yukiko Takakura, Kawasaki-shi (JP); Kazuhiro Hayashi, Kawasaki-shi (JP); Mayuko Iga, Kawasaki-shi (JP); Makoto Yamada, Kawasaki-shi (JP); Takuya Masuzawa, Kawasaki-shi (JP)

(21) Appl. No.: 13/166,989

(22) Filed: Jun. 23, 2011

Related U.S. Application Data
(63) Continuation of application No. PCT/JP2009/071876, filed on Dec. 24, 2009.

(30) Foreign Application Priority Data
Dec. 25, 2008 (JP) 329982/2008

(51) Int. Cl. A23L 1/227; A23L 2/56

(52) U.S. Cl. 426/535

(57) ABSTRACT

The present invention provides a method of producing a composition which is useful for flavoring food or drinks. The method includes utilizing a heating reaction of methionine and a sugar, which results in methional being present in the composition at a higher concentration. The present invention also provides a food, etc. containing the composition produced by the method.

Methionine and a sugar are mixed, and the mixture is heated under a two stage process having particular pH conditions for a particular time at a particular temperature. Moreover, during the mixing and heating of methionine and a sugar, one or more of sodium chloride, potassium chloride, calcium chloride and phosphate is/are added, and the mixture is heated under particular pH conditions for a particular time at a particular temperature.

This application is a Continuation of, and claims priority under 35 U.S.C. §120 to, International Application No. PCT/JP2009/071876, filed Dec. 24, 2009, and claims priority therethrough under 35 U.S.C. §119 to Japanese Patent Application No. 2008-329982, filed Dec. 25, 2008, the entireties of which are incorporated by reference herein.

### BACKGROUND OF THE INVENTION

1. Field of the Invention

The present invention relates to a method of producing a composition that can be used for flavoring food or drink. The method utilizes a reaction of methionine and a sugar while heating, which results in a composition containing methional at a high concentration. The present invention also relates to foods containing a composition produced by the method.

2. Brief Description of the Related Art

The Maillard reaction occurs when an amino acid and a sugar are heated together. This reaction is known to produce various aromatic compounds, which give off a roasted meat smell, and the like. Therefore, these compounds are often utilized as seasonings and for imparting flavor and/or aroma to foods (JP-A-01-206968).

Methional is produced by a Maillard reaction between methionine and a sugar (J. Agric. Food Chem., 47, 2355, 1999 and J. Agric. Food Chem., 43, 1641, 1995), and has recently been reported as being useful as a flavoring agent in steamed potatos and meat.

Since the Maillard reaction involves complicated reaction steps, it is difficult to obtain necessary flavor compounds at a high purity. In some reports, however, an attempt has been made to improve the reaction, as shown in J. Agric. Food Chem., 52, 953, 2004.

### SUMMARY OF THE INVENTION

In the production methods reported in the above-referenced patent documents, the components were identified but not quantified, and the methional content is low which poses a problem for practical use. Phosphate catalyzes production of dicarbonyl compounds by promoting sugar decomposition (see J. Agric. Food Chem., 52, 953, 2004); however, the use of phosphate in a heating reaction system of methionine, or a method of promoting production of Strecker aldehyde such as methional and the like by causing Strecker degradation, has not been previously reported.

It is an aspect of the present invention to provide a method of producing a composition that is useful as a flavoring agent in food and drink by utilizing a heating reaction of methionine and a sugar. This method results in a composition with a higher concentration of methional. It is another aspect of the present invention to provide food, etc., containing a composition produced by the production method.

It is an aspect of the present invention to provide a method of producing a composition comprising mixing methionine and a sugar, heating the methionine and sugar mixture in a first stage of heating to a temperature of not lower than 40° C. and not higher than 180° C. for not less than 15 min and no more than 10 hr with a pH of pH not less than 4.0 and not more than 8.0, then heating the methionine and sugar mixture in a second stage of heating to a temperature of not lower than 40° C. and not higher than 180° C. for not less than 15 min and no more than 10 hr with a pH of not less than 3.0 and not more than 7.0, wherein the pH in the first stage is different from the pH in the second stage by not less than 0.5.

It is another aspect of the present invention to provide a method of producing a composition comprising mixing methionine, a sugar, and a compound selected from the group consisting of sodium chloride, potassium chloride, calcium chloride, and phosphate, and heating the mixture to not lower than 40° C. and not higher than 180° C. for not less than 15 min and no longer than 10 hr at a pH of not less than 3 and not more than 8.

It is a further aspect of the present invention to provide a food comprising the composition produced by a method described above, wherein said composition is present in said food in not less than 1 ppb and not more than 20 wt %.

The present invention provides a method of producing a composition by utilizing a heating reaction of methionine and a sugar, which results in a composition that contains higher concentration of methional. The present invention also provides a food containing the composition produced by the method.

Accordingly, the present invention relates to the following:

[1] A method of producing a composition comprising:

A) mixing methionine, a sugar and a compound selected from the group consisting of sodium chloride, potassium chloride, calcium chloride, phosphate, and combinations thereof, resulting in a mixture, and

B) heating the mixture to not lower than 40° C. and not higher than 180° C. for not less than 15 min and no longer than 10 hr at a pH of not less than 3 and not more than 8.

[2] The method of the above-mentioned [1], wherein the sugar is selected from the group consisting of glucose, xylose, sucrose, maltose, fructose, and combinations thereof.
[3] A method of producing a composition comprising:

A) mixing methionine, a sugar, and a compound selected from the group consisting of sodium chloride, potassium chloride, calcium chloride, phosphate, and combinations thereof, resulting in a mixture, and

B) heating the mixture in two stages, wherein the mixture is heated in a first stage to not lower than 40° C. and not higher than 180° C. for not less than 15 min and no longer than 10 hr at a pH of not less than 4.0 and not more than 8.0, and in a second stage to not lower than 40° C. and not higher than 180° C. for not less than 15 min and no longer than 10 hr at a pH of not less than 3.0 and not more than 7.0,

wherein the pH in the first stage is different from the pH in the second stage by not less than 0.5.

[4] A method of producing a food or drink comprising adding the composition produced by the method of any one of the above-mentioned [1] to [3] to a food or drink.
[5] The method of the above-mentioned [4], wherein the food or drink comprises a meat extract.
[6] A food or drink comprising the composition produced by the method of any one of the above-mentioned [1] to [3], wherein said composition is present in the food or drink at a concentration of not less than 1 ppb and not more than 20 wt %.

### DETAILED DESCRIPTION OF EXEMPLARY EMBODIMENTS

The composition in accordance with the presently disclosed subject matter is produced by a method characterized by a two stages of heating of methionine and a sugar under various pH conditions.

During the two stage heating process, the pH is adjusted so that it is not less than 4.0 and not more than 8.0 during the first stage, and not less than 3.0 and not more than 7.0 during the second stage. In another example, the pH during the first stage is not less than 6.0 and not more than 8.0, and the pH in the second stage is not less than 3.0 and not more than 6.0. In yet another example, the pH in the first stage is not less than 6.5 and not more than 8.0, and the pH in the second stage is not less than 3.0 and not more than 5.5. In addition, the pH in the first stage can be different from the pH in the second stage by not less than 0.5. As the pH deviates from the above ranges, the amount of methional produced may decrease.

Moreover, the temperature during heating is characteristically not lower than 40° C. and not higher than 180° C., and the reaction is heated for not less than 15 min and not more than 10 hr, or in another example, the temperature is not lower than 70° C. and not higher than 120° C., and the heating time is not less than 1 hr and not more than 8 hr. As the heating temperature decreases and the heating time becomes shorter, the amount of the composition decreases. As the heating temperature increases and the heating time becomes longer, flavors in the composition such as a burnt taste and the like increase.

In accordance with the presently disclosed subject matter, while the method for adjusting the pH is not particularly limited as long as a food-safe agent is used, hydrochloric acid, phosphoric acid, citric acid, formic acid, acetic acid, sodium hydroxide, potassium hydroxide, aqueous ammonia and the like are particular examples.

Moreover, one or more of sodium chloride, potassium chloride, calcium chloride and/or phosphate can be present during the heating of the methionine and a sugar. The effect of sodium chloride, potassium chloride, and sodium dihydrogen phosphate can be particularly high.

The composition can include those produced by reacting methionine and a sugar at a particular pH and temperature.

The flavor can refer to the smell and/or taste.

While methionine can be in the D- or L-form, either form or a mixture (racemate) can be used.

The sugar can be any saccharide, such as a monosaccharide, disaccharide, polysaccharide, and the like. Glucose, xylose, sucrose, maltose, and fructose are particular examples, and provide reaction efficiency.

In accordance with the presently disclosed subject matter, the composition can be in any form as long as it is compatible with use in food and drink, and can include a synthesized product, fermented product, and the like. When the composition is added to food, the method in which it is added is not particularly limited, and can include adding the composition directly to the food, or after dilution with water, a solvent and the like. The composition can be added to food by mixing the composition with a yeast extract, meat extract, seafood extract, protein hydrolysate, and the like, or the composition can be added to food as a seasoning composition, during the stewing of meat, and the like.

In addition, the form of the composition is not particularly limited and, for example, the composition can be a dry powder, a paste, a solution, and the like.

Moreover, the food to which the composition is added is not particularly limited, and better results are obtained when using a meat extract, particularly a chicken extract, beef extract, or pork extract. Specifically, European food such as chicken consomme soup, curry, beef stew, white stew, ham, hamburger, steak, and the like, Chinese food, Japanese-style food, various seasonings such as worcester sauce, demi-glace sauce, ketchup, various sauces and flavor seasonings and the like, Japanese-style boiled foods such as simmered meat and potatoes, chicken stew with taro, carrot, burdock, etc., and the like, fried foods such as fried chicken, pork cutlet and the like, and rice such as rice ball, pilaf and the like are particular examples.

As for the concentration of the composition to be added to food, various concentrations of from not less than 1 ppb to not more than 20 wt % at the time of eating or drinking can be used. Examples of the concentration include not less than 10 ppb and not more than 5 wt %, not less than 100 ppb and not more than 1 wt %, or not less than 100 ppb and not more than 10 ppm. When the concentration is too low, the effect cannot be obtained, and when the concentration is too high, the food becomes unnatural and a distasteful artificial flavor can be added.

The present invention is explained in more detail in the following by referring to following non-limiting Examples.

### EXAMPLES

### Example 1

### Evaluation of Methional Concentration by Changes in Reaction pH

Methionine (0.4 g), xylose (0.44 g), and sodium chloride (3.79 g) were mixed and dissolved in water (19.16 g), adjusted to pH 4.5-7.5, and heated to 95° C. for 1 hr, resulting in a methional solution. The same solution was heated to 95° C. for 2 hr at a fixed pH 6.0, and used as a control.

Evaluation Method of Methional:

Analysis Instrument:

GC-MS-GC-MS(5973N) manufactured by Agilent

Auto sampler (pre-treatment, injecting apparatus); MPS2 GESTEL

Analysis Pre-Treatment:

A sample (10 ml) was placed in a 40 ml vial bottle with a septum, and a SPME fiber (65 μm polydimethylsiloxane-divinylbenzene) was exposed to the headspace for 45 min while heating to 50° C. to allow for adsorption of the component.

GC-MS Conditions:

column: TC-5 (0.25 mm×60M, ID=0.25 μm) manufactured by GL Sciences Inc.

injecting conditions: temperature- 200° C., mode- splitless, head pressure- 127 kPa

oven conditions: after maintenance at 50° C. for 5 min, temperature rise to 220° C. at 4° C./min, and maintenance at 220° C. for 5 min.

Flavor analysis was performed by the above-mentioned method. The results are shown in Table 1.

TABLE 1
Methional concentration

| pH in the | pH in the | Methional |
|---|---|---|
| first stage | second stage | concentration (ppm) |
| 4.5 | 4.5 | 54 |
| 4.5 | 5.5 | 120 |
| 4.5 | 6.5 | 118 |
| 4.5 | 7.5 | 63 |
| 5.5 | 4.5 | 131 |
| 5.5 | 5.5 | 68 |
| 5.5 | 6.5 | 127 |
| 5.5 | 7.5 | 64 |
| 6.5 | 4.5 | 147 |
| 6.5 | 5.5 | 134 |
| 6.5 | 6.5 | 76 |
| 6.5 | 7.5 | 56 |
| 7.5 | 4.5 | 186 |
| 7.5 | 5.5 | 170 |
| 7.5 | 6.5 | 143 |
| 7.5 | 7.5 | 58 |

| | |
|---|---|
| control (pH 6.0) | 116 |

From the results of Table 1, the largest amount of methional was produced when the pH in the first stage was set to 7.5 and the pH in the second stage was set to 4.5, and was about 1.6 times that of the control. In addition, the amount of methional produced preferably increased when the pH in the first stage was different than the pH in the second stage, that is, the pH in the first stage was not less than 4.0 and not more than 8.0, and the pH in the second stage was not less than 3.0 and not more than 7.0, as compared to the control and when the pH was the same in the first and second stages. A further increase in methional production was observed when the pH in the first stage was not less than 4.5 and not more than 7.5, and the pH in the second stage was not less than 4.5 and not more than 6.5.

### Example 2

### Evaluation of Methional Concentration Change by Addition of One Kind of Salt

Methionine (0.4 g) and xylose (0.36) were dissolved in water (19.24 g). Then, one of sodium chloride, potassium chloride, calcium chloride, magnesium chloride, iron chloride, sodium carbonate, sodium dihydrogen phosphate, or trisodium citrate was added (0.065 mol) and dissolved therein, and the mixture was heated to 95° C. for 2 hr. A solution containing only methionine, xylose and water was heated to 95° C. for 2 hr and used as a control.

Evaluation Method of Methional

Analysis Instrument:

GC-MS-GC-MS(5973N) manufactured by Agilent

Auto sampler (pre-treatment, injecting apparatus)-MPS2 GESTEL

Analysis Pre-Treatment:

A sample (10 ml) was placed in a 40 ml vial bottle with a septum, and a SPME fiber (65 μm polydimethylsiloxane-divinylbenzene) was exposed to the headspace for 45 min while heating to 50° C. to allow adsorption of the component.

GC-MS Conditions:

column: TC-5 (0.25 mm×60M, ID=0.25 μm) manufactured by GL Sciences Inc.

injecting conditions: temperature- 200° C., mode- splitless, head pressure- 127 kPa

oven conditions: after maintenance at 50° C. for 5 min, temperature rise to 220° C. at 4° C./min, and maintenance at 220° C. for 5 min.

Flavor analysis was performed by the above-mentioned method. The results are shown in Table 2.

TABLE 2
Methional concentration

| | Methional |
|---|---|
| | concentration (ppm) |
| control | 79 |
| sodium chloride | 140 |
| potassium chloride | 134 |
| calcium chloride | 83 |
| magnesium chloride | 55 |
| iron chloride | 0 |
| sodium carbonate | 0 |
| sodium dihydrogen phosphate | 222 |
| trisodium citrate | 0 |

The results in Table 2 show that the amount of methional produced increased as compared to the control when sodium chloride, potassium chloride, calcium chloride, or sodium dihydrogen phosphate was added, and the amount of methional produced decreased as compared to the control when magnesium chloride, iron chloride, or sodium carbonate was added.

### Example 3

### Evaluation of Methional Concentration Change when Two Kinds of Salts are Added

Methionine (40 g) and xylose (44 g) were mixed and dissolved in water (1916 g), adjusted to pH 7.5, and heated to 95° C. for 1 hr. Sodium dihydrogen phosphate (78 g, 0.65 mol) and sodium chloride (379 g, 6.49 mol) were added to this solution and dissolved therein, and the mixture was adjusted to pH 4.5, and heated to 95° C. for 1 hr to give a methional solution. The same solution without the addition of sodium dihydrogen phosphate and sodium chloride was heated to 95° C. for 2 hr at a fixed pH 5.6 and used as a control.

Evaluation Method of Methional:

Analysis Instrument:

GC-MS—GC-MS(5973N) manufactured by Agilent

Auto sampler (pre-treatment, injecting apparatus); MPS2 GESTEL

Analysis Pre-Treatment:

A sample (10 ml) was placed in a 40 ml vial bottle with a septum, and a SPME fiber (65 μm polydimethylsiloxane-divinylbenzene) was exposed to the headspace for 45 min while heating TO 50° C. to allow adsorption of the component.

GC-MS Conditions:

column: TC-5 (0.25 mm×60M, ID=0.25 μm) manufactured by GL Sciences Inc.

injecting conditions: temperature- 200° C., mode- splitless, head pressure- 127 kPa

oven conditions: after maintenance at 50° C. for 5 min, temperature rise to 220° C. at 4° C./min, and maintenance at 220° C. for 5 min.

Flavor analysis was performed by the above-mentioned method. The results are shown in Table 3.

TABLE 3
Methional concentration

| | Methional |
|---|---|
| | concentration (ppm) |
| control | 79 |
| addition of sodium dihydrogen | 356 |
| phosphate and sodium chloride | |

The results in Table 3 show an improvement in the methional concentration of 4.5-fold higher than the control by adding a combination of sodium dihydrogen phosphate and sodium chloride before the second heating step, and heating in the acidic range. Moreover, methional was produced in a higher amount as compared to the addition of sodium dihydrogen phosphate or sodium chloride alone.

### INDUSTRIAL APPLICABILITY

The present invention provides a method of producing a flavor composition by utilizing a heating reaction of methionine and a sugar, which results in a higher concentration of methional, and a food containing a composition produced by the production method.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in their entireties.

1. A method of producing a composition comprising:
A) mixing methionine, a sugar and a compound selected from the group consisting of sodium chloride, potassium chloride, calcium chloride, phosphate, and combinations thereof, resulting in a mixture, and
B) heating the mixture to not lower than 40° C. and not higher than 180° C. for not less than 15 min and no longer than 10 hr at a pH of not less than 3 and not more than 8.

2. The method of claim 1, wherein the sugar is selected from the group consisting of glucose, xylose, sucrose, maltose, fructose, and combinations thereof.

3. A method of producing a composition comprising:
A) mixing methionine, a sugar, and a compound selected from the group consisting of sodium chloride, potassium chloride, calcium chloride, phosphate, and combinations thereof, resulting in a mixture, and
B) heating the mixture in two stages, wherein the mixture is heated in a first stage to not lower than 40° C. and not higher than 180° C. for not less than 15 min and no longer than 10 hr at a pH of not less than 4.0 and not more than 8.0, and in a second stage to not lower than 40° C. and not higher than 180° C. for not less than 15 min and no longer than 10 hr at a pH of not less than 3.0 and not more than 7.0,
wherein the pH in the first stage is different from the pH in the second stage by not less than 0.5.

4. A method of producing a food or drink comprising adding the composition produced by the method of claim 1 to a food or drink.

5. A method of producing a food or drink, comprising adding the composition produced by the method of claim 2 to a food or drink.

6. A method of producing a food or drink, comprising adding the composition produced by the method of claim 3 to a food or drink.

7. The method described in claim 4, wherein the food or drink comprises a meat extract.

8. The method of claim 5, wherein the food or drink comprises a meat extract.

9. The method of claim 6, wherein the food or drink comprises a meat extract.

10. A food or drink comprising the composition produced by the method of claim 1, wherein said composition is present in the food or drink at a concentration of not less than 1 ppb and not more than 20 wt %.

11. A food or drink comprising the composition produced by the method of claim 2, wherein said composition is present in the food or drink at a concentration of not less than 1 ppb and not more than 20 wt %.

12. A food or drink comprising the composition produced by the method of claim 3, wherein said composition is present in the food or drink at a concentration of not less than 1 ppb and not more than 20 wt %.
